(19) United States
(12) Patent Application Publication
(10) Pub. No.: US 2017/0053496 A1
(43) Pub. Date: Feb. 23, 2017

(54) GAMES AND GAMING MACHINES HAVING PUZZLE FEATURE

(71) Applicants: Milo Borissov, Dubai Sports City (AE); Rossi McKee, Indianapolis, IN (US)

(72) Inventors: Milo Borissov, Dubai Sports City (AE); Rossi McKee, Indianapolis, IN (US)

(21) Appl. No.: 14/828,824

(22) Filed: Aug. 18, 2015

(51) Int. Cl. G07F 17/32; A63F 9/06

(52) U.S. Cl. CPC G07F 17/3267; A63F 9/0612; G07F 17/3211; G07F 17/3225; G07F 17/3244

(57) ABSTRACT

The present invention is a gaming device and method associated with the accumulation of puzzle pieces to generate an image associated with an award and can be practiced separately or preferably as a bonus in conjunction with a primary or base game. A series of random selections of symbols from a symbol set for placement in a plurality of positions of a symbol array include at least one special symbol that locks in position and remains static during subsequent symbol selections. Each locked special symbol establishes an image piece associated with the given position of the special symbol. If a special symbol is selected for each position of the symbol array prior to or upon the last in the series of selections, an image associated with an award is fully displayed.

### FIELD OF THE INVENTION

The present invention relates to methods of presenting and playing games and gaming machines configured to present games.

### BACKGROUND OF THE INVENTION

Slot machine games have been enjoyed by players for many years. Game developers and manufacturer have sought to improve the games over the years through various means to increase player enjoyment and to attract players to their games or gaming machines. Slot machines began as strictly mechanical devices and later developed into electro-mechanical devices and then predominantly electronic devices that delivered games to a display screen as computer generated graphics and animation. The slot machine was then referred to more often as a video slot machine, electronic gaming machine or, simply, gaming machine.

With the advent of electronic gaming machines that could display video slot type game on a computer display screen, the nature of the games became more sophisticated in display as well as game methodology. Game methods were no longer restricted to only basic symbol combinations along a limited and minimal number of paylines. Gaming methods for video slot games became bounded only by the developer's imagination, limits of the gaming device, and jurisdictionally mandated regulations.

First, the video slot games added various bells and whistles to better entertain the player and add excitement, such as multiple paylines, variable denomination play and wager amounts, scatter symbols, progressive jackpots. Mostly later, bonus games were introduced. Based on certain criteria in the “base” game, a random event or other criteria unrelated to the particular game, the player might be awarded an additional bonus game or feature. This extended the play of the game and added even further enjoyment and excitement to the play of the game.

Thus, game developers and manufacturers are always striving to come up with new and exciting ways to deliver games to players. Unique bonus games are one important means for doing so. One of the most popular of bonus games provided to players are “free spin” bonus games. Free spin bonus games provide the player an opportunity to “spin” the computer generated video reels of a game a number of times. For each spin, the player is provided the chance to receive a monetary or other prize award, or another feature. The free spin bonus game may consist of the same set of symbols as those of the base game and would then be just like playing the base game; only multiple additional times for free. Other times, the free spin bonus game may provide a video slot game made up of different symbols having weighted outcomes. Therefore, a greater or lesser award per spin (preferably greater) would occur than that provided in the base game.

Developers have come up with various forms of free spin bonus games, but new and more exciting free spin bonus games are desired.

### SUMMARY OF THE INVENTION

Embodiments of the invention comprise methods and systems for playing a game on an electronic gaming machine whereby images are formed from image or puzzle pieces associated with the various positions of a symbol array (also referred to hereinafter as the matrix). The game can be played alone or in association with a primary or base game. When played in association with a primary or base game, the game is a bonus game. The base game triggers the initiation of the bonus game. Once triggered, the bonus game is displayed on a display device of the electronic gaming machine. The bonus game comprises a number of “spins” and is thus known in the industry as a free spin game or free spin bonus. The symbols are selected from a symbol set comprising a plurality of different symbols and associated with various positions of the symbol array. Each spin comprises a random selection of symbols from the symbol set for each of the plurality of symbol positions. In the preferred embodiment, the spins are visually simulated to be spinning reels of a slot machine game. However, any manner of visually removing the previous symbol from the position and replacing it with a new, randomly selected symbol will suffice.

An object of the invention is the use of a special symbol included in the symbol set which possesses the unique attribute of sticking or locking to the position in which it was selected and remaining static within that position for the remainder of spins. When a re-selection of symbols is initiated for each of the positions, the position holding the special symbol will not be replaced but will statically remain in place.

Another object of the invention is the association of an image piece with each of the positions of the symbol array. Thus, each position is associated with a unique image piece, but the image piece is not activated unless a special symbol is selected for each of the symbol positions during the number of spins allocated to the bonus game. The plurality of image pieces for each of the positions of the symbol array, if activated, will form a complete image.

In yet another object of the invention, accumulation of special symbols within each of the plurality of symbol positions activates the image pieces and causes each to be aesthetically displayed to form the complete image. The formation of the complete image is further associated with an award.

In another embodiment of the invention, the image piece is activated upon selection in the special symbol within a given symbol position. Therefore, in this embodiment, the image piece is displayed prior to the selection and display of the special symbol for each and all positions of the symbol array. In this manner, the image grows with the accumulation of special symbols until, if the goal is achieved within the allotted number of spins, the complete image is displayed.

The embodiment described above can also be practiced in association with a gaming system. A server would be configured to communicably interface with a number of remote client devices. Such devices would receive streaming video of the game and have a display for presenting such to the player. Input devices on the devices would allow for wagering and operation of the game.

Further objects, features, and advantages of the present invention over the prior art will become apparent from the detailed description of the drawings which follows, when considered with the attached figures.

### DESCRIPTION OF THE DRAWINGS

FIG. 1 illustrates a gaming machine of the type which may be used to implement a game in accordance with the present invention;

FIG. 2 is a flow chart which illustrates the process associated with the gaming method;

FIGS. 3a-3b, 4, 5a-5b and 6a-6b illustrate a sequence of game play in accordance with a game of the present invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention comprise methods of playing and presenting games. In a preferred embodiment, the methods of game play and presentation are implemented via a gaming machine or device. Such a gaming machine may have various configurations.

The gaming machine may be located at a casino (and as such may be referred to as a “casino gaming machine”). As described below, the gaming machine may be part of a gaming system, such as a casino gaming system which links two or more of the gaming machines or one or more gaming machines with other devices, such as one or more table games, kiosks, accounting systems or servers, progressive systems or servers, player tracking systems or servers or the like.

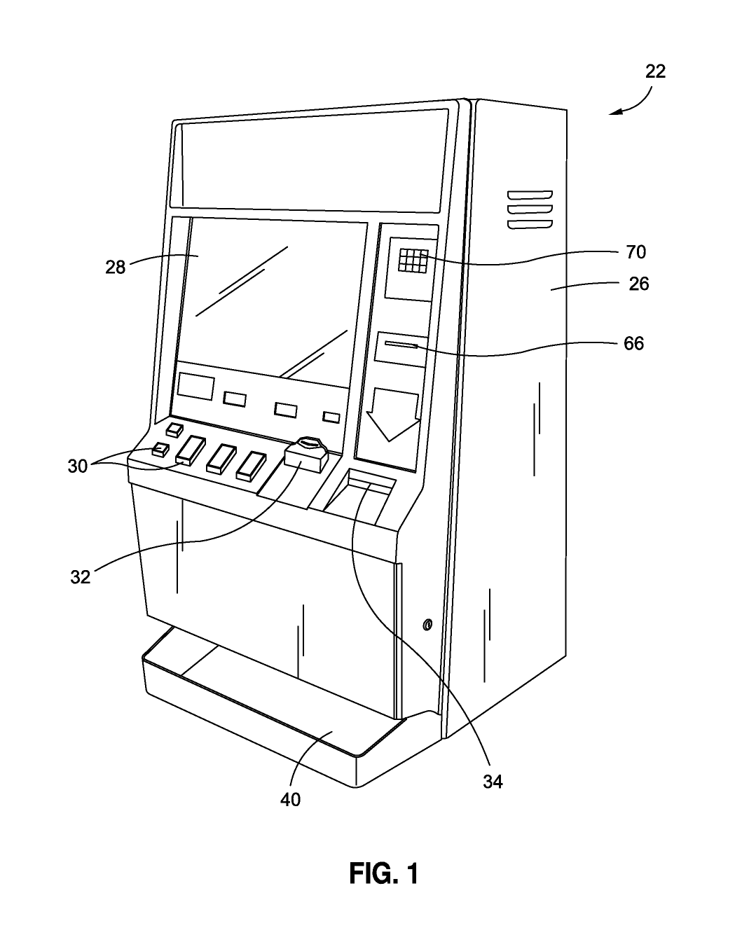

One configuration of a gaming machine 22 is illustrated in FIG. 1. As illustrated, the gaming machine 22 generally comprises a housing or cabinet 26 for supporting and/or enclosing various components required for operation of the gaming machine. In the embodiment illustrated, the housing 26 includes a door located at a front thereof, the door capable of being moved between an open position which allows access to the interior, and a closed position in which access to the interior is generally prevented. The configuration of the gaming machine 22 may vary. In the embodiment illustrated, the gaming machine 22 has an “upright” configuration. However, the gaming machine 22 could have other configurations, shapes or dimensions (such as being of a “slant”-type, “bar-top” or other configuration as is well known to those of skill in the art).

The gaming machine 22 preferably includes at least one display device 28 configured to display game information. The display device 28 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display 28 may be capable of projecting or displaying a wide variety of information, including images, symbols and other indicia or information associated with game play, game promotion or other events. The gaming machine 22 might include more than one display device 28, such as two or more displays 28 which are associated with the housing 26. The gaming machine 22 might also include a top box or other portion. Such a top box might include one or more display devices 28, such as in addition to one or more main displays which are associated with the housing 26. Also, the gaming machine 22 might include side displays (such as mounted to the exterior of the housing 26) and might include multiple displays of differing sizes. The gaming machine 22 might also include other types of game information display devices, such as one or more spinning mechanical reels, wheels or the like.

For example, the gaming machine 22 may include one or more physical reels capable of displaying symbols. In such a configuration, means are provided for rotating the physical reels. In one or more embodiments, the means may comprise a mechanical linkage associated with a spin arm, with movement of the spin arm (a “pull”) by a user causing the reels to spin. In such an arrangement, the reels are generally allowed to free-wheel and then stop. In another embodiment, electronically controlled mechanisms are arranged to rotate and stop each reel. Such mechanisms are well known to those of skill in the art. In this arrangement, actuation of the spin arm or depression of a spin button causes a controller (not shown) to signal the activation of the spin mechanism associated with one or more of the reels. Preferably, the controller is arranged to either turn off the signal to the device(s) effecting the rotation of each or all of the reels or generates a signal for activating a braking device, whereby the reels are stopped. As is well known, the combinations of reel positions and their odds of hitting are associated with the controller, and the controller is arranged to stop the reels in a position displaying a combination of indicia as determined by the controller based on the combinations and odds. The principal of such an arrangement is described in U.S. Pat. No. 4,448,419 to Telnaes, which is incorporated herein by reference. For example, the base symbols might be associated with spinning reels. Sets of base symbols might be generated by spinning those reels.

As described in more detail below, the gaming machine 22 is preferably configured to present one or more games upon a player making a monetary payment or wager. In this regard, as described in more detail below, the gaming machine 22 includes means for accepting monetary value.

In one embodiment, as detailed above, certain game outcomes may be designated as winning outcomes. Prizes or awards may be provided for winning outcomes, such as monetary payments (or representations thereof, such as prize of credits), or promotional awards as detailed herein. As detailed below, the gaming machine 22 includes means for returning unused monetary funds and/or dispensing winnings to a player.

The gaming machine 22 preferably includes one or more player input devices 30 (such as input buttons, plunger mechanisms, a touch-screen display, joystick, touch-pad or the like). These one or more devices 30 may be utilized by the player to facilitate game play, such as by providing input or instruction to the gaming machine 22. For example, such input devices 30 may be utilized by a player to place a wager, cause the gaming machine 22 to initiate a game, to indicate cards to be held or discarded, to “cash out” of the gaming machine, or to provide various other inputs.

In one preferred embodiment, the gaming machine 22 includes at least one microprocessor or controller for controlling the gaming machine, including receiving player input and sending output signals for controlling the various components of the machine 22 (such as generating game information for display by the display 28). The controller may be arranged to receive information regarding funds provided by a player to the gaming machine, receive input such as a purchase/bet signal when a purchase/bet button is depressed, and receive other inputs from a player. The controller may be arranged to generate information regarding a game, such as generating game information for display by the at least one display 28 (such as information representing images of displayed cards), for determining winning or losing game outcomes and for displaying information regarding awards for winning game outcomes, among other things.

The controller may be configured to execute machine readable code or “software” or otherwise process information, such as obtained from a remote server. Software or other instructions may be stored on a memory or data storage device. The memory may also store other information, such as pay table information. The gaming machine 22 may also include one or more random number generators for generating random numbers, such as for use in selecting cards, symbols and/or for otherwise presenting the game in a random fashion.

Preferably, the controller is configured to execute machine readable code or instructions which are configured to implement the method of game play of the invention. For example, the controller of the gaming machine 22 may be configured to detect a wager, such as a signal from a player's depressing of the “bet one” button. Upon such an event and/or the player otherwise signaling the gaming machine to present the game, the controller may be configured to cause game symbols or other game information to be displayed on the at least one display 28. The controller may accept input from a player of game inputs, such as a request to spin reels or the like, via the one or more player input devices of the gaming machine 22.

The gaming machine 22 may be configured to generate and present games in a stand-alone manner or it may be in communication with one or more external devices at one or more times. For example, the gaming machine 22 may be configured as a server based client and obtain game code or game outcome information from a remote game server (in which event the gaming machine controller may receive game information from the server, such as game outcome information, and use that server-generated information to present the game at the gaming machine).

As indicated, the gaming machine 22 is configured to present one or more wagering games. Thus, the gaming machines 22 is preferably configured to accept value, such as in the form of coins, tokens, paper currency or other elements or devices representing value such as monetary funds. For example, as illustrated in FIG. 1, the gaming machine 22 might include a coin acceptor 32 for accepting coins. Of course, associated coin reading/verifying devices and coin storage devices may be associated with the gaming machine 22 if it is configured to accept coins. Likewise, the gaming machine 22 might include a media reader 34. Such a reader may be configured to accept and read/verify paper currency and/or other media such as tickets. Of course, in such event the gaming machine 22 may further be configured with one or more paper currency or ticket storage devices, such as cash boxes, and other paper currency or media handling devices (including transport devices).

The gaming machine 22 might also be configured to read FOBs, magnetic stripe cards or other media having data associated therewith and via which value or funds may be associated with the gaming machine 22.

In one embodiment, the gaming machine 22 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. For example, upon an award or at cash-out, associated funds may be paid to the player by the gaming machine 22 dispensing coins to a coin tray. In another embodiment, funds may be issued by dispensing paper currency. In yet another embodiment, a player may be issued a media, such as a printed ticket, which ticket represents the value which was paid or cashed out of the machine. The aspects of gaming machine “ticketing” systems are well known. One such system is described in U.S. Pat. No. 6,048,269 to Burns, which is incorporated herein in its entirety by reference.

The gaming machine 22 may also include a player tracking device, such as a card reader 66 and associated keypad 70. Such player tracking devices are well known and may permit the game operator to track play of players of the gaming machine. The tracked play may be utilized to offer player bonuses or awards.

It will be appreciated that the gaming machine illustrated in FIG. 1 is only exemplary of one embodiment of a gaming machine. For example, it is possible to for the gaming machine to have various other configurations, including different shapes and styles and having different components than as just described.

For example, it is possible for the game of the invention to be presented on a computing device, including at a home or office computer or a player's mobile electronic device such as a PDA, phone or the like. In one embodiment, a player might log in to a casino server and the controller of the casino server may cause game information to be delivered to the player's computer via a communication link and then be displayed on a display of the player's computer. The communication link might comprise or include the Internet, a casino network such as a wired or wireless LAN, or combinations of public and/or private networks including wired and/or wireless links. In such a configuration it will be noted that the term “controller” may comprise more than one device. For example, in a server-based environment, a controller at a server may generate game information and transmit that information to a local controller at a gaming machine or a player's computer or other electronic device. The local controller at the gaming machine or the player's computer or other electronic device may then cause game information to be displayed on one or more associated displays.

A casino may have numerous such gaming machines 22, such as located on a casino floor or in other locations. Of course, such gaming machines 22 might be used in other environments, such as an airport, a bar or tavern or other locations.

When a home or office computer or a player's mobile electronic device such as a PDA, phone or the like is used, the devices may be located nearly anywhere. In the server-based environment, gaming may be conducted over the Internet. Such gaming may take the form or real money wagered gaming in jurisdictions where such gaming is legal. But gaming may also be conducted in association with social gaming Internet sites where the player wagers virtual currency. Virtual currency is currency that only has value for the play of games at a virtual gaming site. Virtual currency is provided by the gaming site for free or can be purchased in certain quantities for relatively low cost. The virtual currency has no tradable value outside of the virtual gaming site.

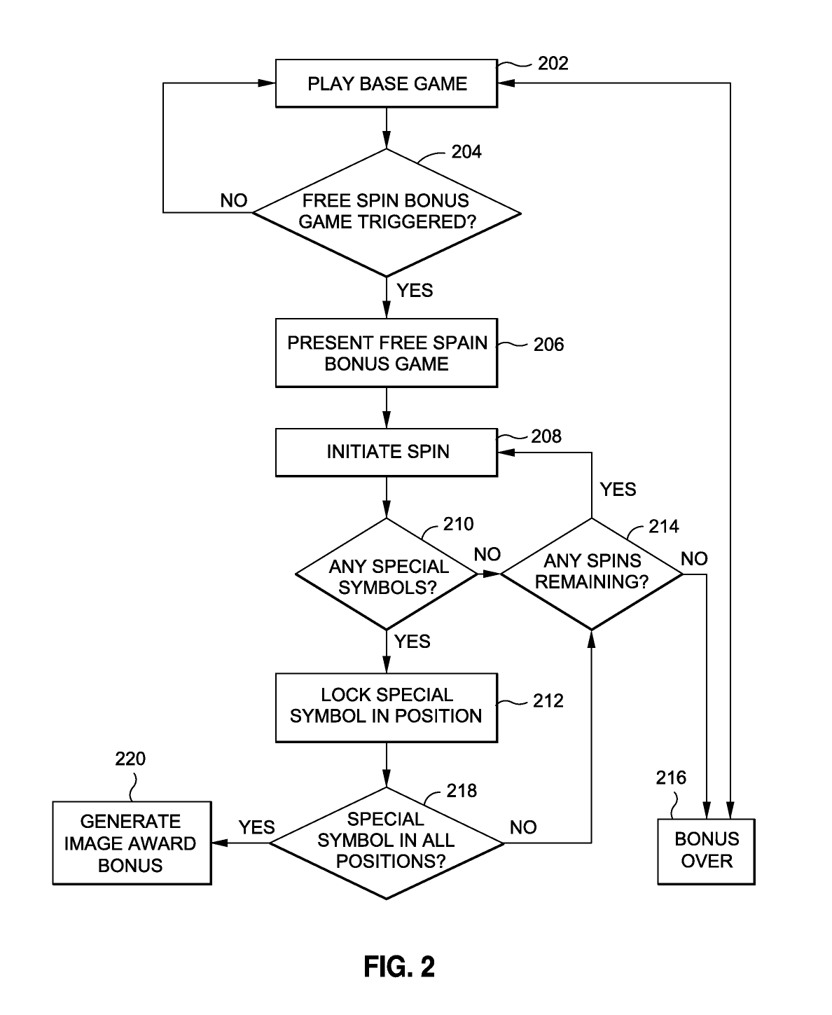

One embodiment of a method of playing and presenting a game in accordance with an embodiment of the invention will be described with reference to FIG. 2. One aspect of the invention is a puzzle type game or event. In one embodiment, the game or event may be presented as a bonus game or event from a base game. In such an embodiment, the first step in the method is the play of a base game 202. The base game might comprise a video slot game, a mechanical reel slot game, video poker or any other type of game. As is known in the art, many such games include associated bonus or feature games. It is thus determined if the bonus game has been triggered 204. Bonus games (also referred to as feature games or events) may be triggered upon a predefined outcome of the base game, randomly, or upon some type of triggering event. Triggering events associated with base game outcomes in a video or mechanical reel slot game are generally associated with one or more symbol combinations along a payline, or the generation of a predetermined number of scatter symbols or a special bonus triggering symbol within the slot games' symbol array. Scatter symbols are symbols that, when a pre-determined number are generated in the symbol array, result in an award regardless of whether or not they are generated along a payline. They can appear at any location within the array or at specified locations, but are independent of payline.

When the trigger is randomly occurring, a random number generator might be accessed upon the play of the base game to see if the bonus game will trigger. Other types of triggering events that could initiate the bonus game might be associated with time, such as triggering the bonus a prescribed times of day. Or, the triggering event might be machine dependent, such as triggering the bonus upon after a certain number of plays or credits wagered. Additionally, the trigger could involve criteria concerning the particular player. The latter would access the player tracking system to identify the particular player using the gaming machine and the player's record of activity. If such activity level—which may be associated with the particular machine the player is playing, the particular game the player is playing, or associated with overall play at the casino where the player is playing—has met a defined threshold, the player would then be awarded a triggering of the bonus game.

In the present embodiment, the triggering event results in a free spin bonus game 206. The free spin bonus game presents the player with a set of symbol positions, such as a symbol array with symbols to be randomly drawn from a set of symbols. The array can consist of any size matrix; e.g. 3×3, 4×5 or 5×5 (or the array could be irregular in shape, such a comprising a pyramid of symbol positions). A 3×3 matrix would consist of three columns and three rows with nine distinct fields or positions. Preferably, symbols are displayed in the symbol positions (the symbol positions may be displayed to the player or might be virtual). The displayed symbols may be generated or displayed in various ways. In one embodiment, the symbols are selected from one or more sets of symbols. For example, a set of symbols may be assigned for each separate row, column, symbol position or for the entire array. Each symbol may be weighted such that a random number generator that determines which symbols are to be visually generated within each position of the matrix may favor the selection of some symbols more than the selection of others. Thus, for a symbol set Sᵢ, where ᵢ=1-13, S₁ may be weighted most heavily, occurring for instance 50 times within the symbol set, and where S₁₃ may be weighted the least, perhaps occurring 5 times within the symbol set. Additionally, the weight per symbol may vary according to the symbol set assigned per column and some column-specific symbol sets may even include additional distinct symbols not found in other column-specific symbol sets. In a preferred embodiment where the base game consists of a video or mechanical slot game, the symbol set(s) and the weight of each symbol may be the same as that provided in the base game, or the symbol set(s), number of distinct symbols, and/or the weight of each symbol may be different for the bonus game. The symbol array may be visually generated in the same display 28 as that used for the base game or it might be displayed in a second display.

Although the base game was described to be any of a video slot game, a mechanical slot game, or any other type of wager-based game, in a preferred embodiment the free spin game of the present invention is a video slot game or video slot-type game. Symbols are generated or displayed into each of the positions of the symbol matrix. The game may be presented through the video-generated appearance of spinning reels, but it is sufficient that the symbol array is randomly re-arranged from symbols of the symbol set(s) after each spin. In the free spin game, the player is provided a set number of free spins. The number of free spins in the bonus game may vary depending on the results of the base game or other condition that triggered the bonus game.

During presentation of the free spin bonus game, the video reels are initiated to “spin” 208. The free spin bonus game generates varying random symbol outlays within the symbol array upon each play or spin of the game. The spins may occur through player input using the player input device 30 of the gaming machine 22 or automatically commence after the completion of the previous spin. The free spin game may award the player a monetary award, depending on the outcome, upon each spin of the bonus game. For instance, the game may provide an award for symbol combinations or payline wins or for the occurrence of a special symbol, including one or more scatter symbols. Additionally, the free spin bonus game may include designated symbols that add to or subtract from the number of spins awarded in the bonus game, or a designated symbol that triggers a peripheral bonus game or event that can result in an award or additional free spins in the primary bonus game. A spin count showing the number of remaining spins in the bonus game may be indicated per a visual meter display (not shown) on the video screen 28 of the gaming machine 22. The starting count will show the number of spins awarded in the bonus game and will decrement after each spin. If a special symbol is generated during a free spin, free spins will be added or subtracted and the meter display will be adjusted to reflect the change in the number of free spins remaining in the bonus game.

Award outcomes may result from each spin. Such outcomes may be generated as a result of payline wins, scatter symbol wins, symbols triggering secondary bonus events, or any manner of winning outcomes associated with slot games. The awards may be shown in secondary meter display as credits won in the bonus game. Alternatively, the number of credits stored by the gaming machine 22 may be updated to reflect the addition of awarded credits.

In the free spin bonus game, at least one special symbol having a unique attribute, as will be later described, is included in the one or more symbol sets. If the game is designed to assign column-specific symbol sets for each column, the special symbol is included in each of the column-specific symbol sets so that a special symbol can be received in each of the symbol positions. The special symbol may also exist in the symbol set(s) of the base game, but need not include the unique attribute associated with the special symbol in the bonus game.

After each spin 208 of the bonus game, the controller of the gaming machine 22 causes the processor to determine if one or more special symbols were generated within the symbol array 210. If so, the game program provides instructions to the controller to “lock” the special symbol(s) in place at their respective positions 212. In so doing, the special symbols generated during that spin of the bonus game, if any, are statically held in position; i.e. made to “stick” in place at their respective position(s) of the matrix. If no such special symbols are found after the completion of the spin, then a determination is made by the processor to determine if there are any spins remaining in the bonus game 214. If there are spins remaining, then the free spin bonus game continues to be played and the matrix is randomly re-populated with symbols from the symbol set with a new initiated “spin” 208. Thus, another spin is made and the process repeats. A subsequent determination is again made to determine if any special symbols were generated within any of the positions of the matrix 210. If it had been determined that no spins were remaining in the bonus game when the game logic checked to see if any spins were remaining 214, then the bonus game would be over 216. This might be displayed to the player by the meter count on the meter display showing “zero” remaining free spins. The player could elect to re-play the base game 202 and receive another chance at triggering the free spin bonus.

When a special symbol is generated in the symbol array, it is locked or made to stick in place 212. During subsequent spins the special symbol remains static—held in its respective position—while other positions of the symbol matrix randomly generate new or the same symbols therein from the applicable symbol set. Symbol generation is preferably displayed as spinning reels with the locked special symbols remaining static such that the special symbols do not appear to be spinning with the other symbols of the symbol set. Another determination 210 is made to determine if any special symbols were generated in the symbol array during any subsequent spins.

Each position of the matrix is associated with a subset or portion of an image. An additional attribute of the special symbols is to enable the generation of, or reveal, that portion of the image upon occurrence of the special symbol at the associated position. In this manner, each position of the matrix is similar to that of a puzzle piece with the entire matrix being the resultant puzzle. In a preferred embodiment, no portions of the image, as defined by matrix positions having special symbols generated therein, are displayed unless each position of the matrix has generated a special symbol. The special symbols remain fixed in place and displayed unless and until a special symbol is displayed in each and every position of the matrix. In the event all positions do display a special symbol, the matrix display is re-generated to display each portion of the image and therefore the image in its entirety 220. The image may take any form, including that of a person, place or thing, and/or the display of a winning bonus award.

In an alternative embodiment, the image portions or puzzle pieces may be generated at each associated position upon or after a predefined time delay at their respective position to display a portion of the entire image. The image will therefore become more and more complete as special symbols appear during subsequent spins of the free spin bonus game.

In yet another embodiment, the image or puzzle pieces may be included in the set of symbols with a set assigned to each column of the matrix. Each column-specific symbol set will thus be comprised of those image or puzzle pieces associated with positions in that column. If an image piece is randomly generated within the associated matrix position, it will lock in place and remain there throughout the remainder of the spins. Conversion from the special symbol to the image or puzzle piece therefore does not occur under this embodiment.

In a further embodiment, the image may include animations or video, or there may be no image but just the display of an animation or video. Such displays may encompass the entire portion of the display or that portion bounded by the matrix, or may be embedded within the image.

Each time a special symbol locks in place or sticks to the position in which it was generated 212, the processor makes a determination to see if each position of the matrix includes a special symbol; i.e. if the last puzzle piece has been added to complete the puzzle and if the yet to be generated image is complete 218. If so, the full image is generated or revealed 220. In a preferred embodiment, a bonus award is concurrently provided 220. The bonus may comprise a set award of credits, a progressive jackpot, a physical item, a random item or number of credits, or any other type of award, including the chance to play yet another game or bonus event.

However, if all of the special symbols have not been generated at each of the positions of the matrix, the determination 218 causes the processor to then make another determination 214 as to whether any free spins remain. If so, the process begins anew and another spin is initiated 208. If not, the bonus game will terminate 216. Therefore, a determination is made after each spin as to whether or not another spin remains. The determination is made when no special symbols are determined during the present spin 214 and when a special symbol is present during the subject spin 218. It is only if a special symbol exists in all positions that determinations will no longer be made.

Embodiments of the present invention therefore involve a reiterative, looping process that provides for multiple spins of a video-slot or video-slot type bonus game with at least one objective being the generation of special symbol outcomes. Another goal is to have the special symbols accumulate as more spins are made until each position of the matrix has generated a special symbol during the allotted spins of the bonus game. Yet another goal is to generate an image from a portion of images associated with each position of the matrix, the generation of which being associated with a bonus award.

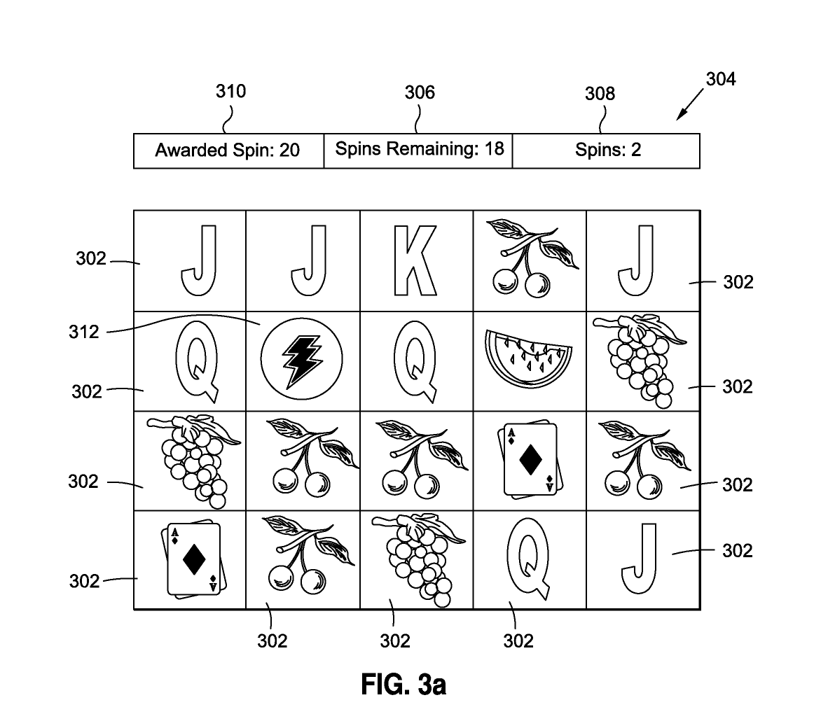

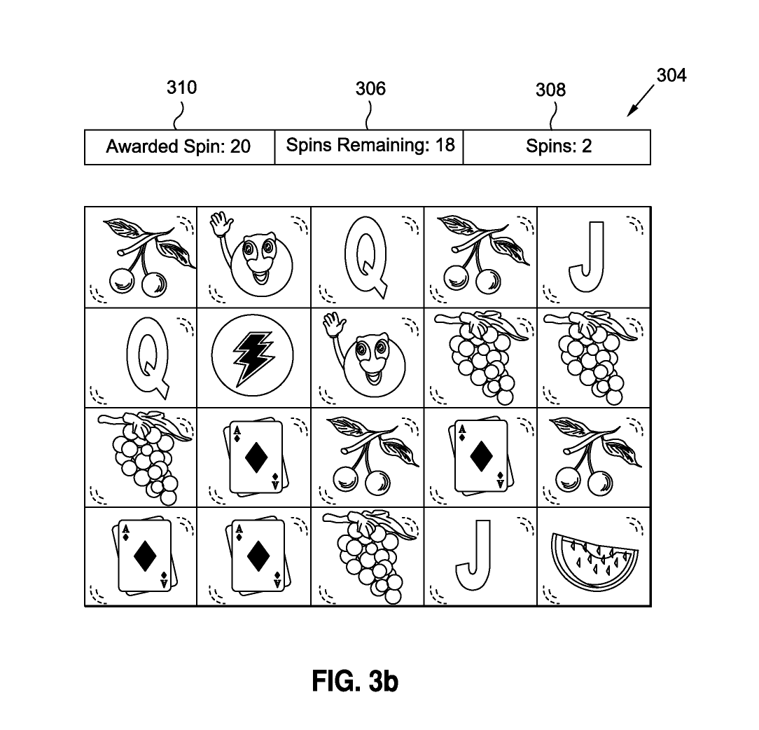

FIG. 3(a) shows an embodiment of the present invention after a spin in the bonus game and before a next spin. The display 28 of the gaming machine 22 is depicted in FIG. 3(a) and shows a 4×5 matrix with a variety of symbols 302 from the symbol set(s) displayed therein. A meter display 304 is shown indicating the number of spins remaining in the bonus game 306, the number of free spins already played 308, and the number of free spins that were awarded by the based game triggering event 310. One of the symbols is a special symbol 312, which is displayed in position 2, 2 (second row, second column) of the matrix. The meter display indicates that two spins have already been played in the bonus game. During one of the prior spins, the special symbol 312 was randomly generated in that position. The special symbol will remain locked in position 2, 2 for the remainder of the bonus game. In another embodiment, a designated symbol generated adjacent to or at a given position in the matrix could dislodge the special symbol, or all or some special symbols, to add an extra measure of excitement to the bonus game. In such an embodiment, the special symbol would need to re-generate at those positions to once again obtain a lock on the respective position.

Since eighteen (18) spins are shown to remain 306, as indicated by the meter display 304, the player would depress the applicable button of the button panel 30 or the respective area of the display 28 if the display utilizes a touch screen interface and input can be provided there from. Alternatively, the spins can be initiated automatically without player input. FIG. 3(b) shows all of the symbols 302 of the matrix, except for the special symbol 312, being re-generated. In this instance, re-generation comprises a visual depiction of the reels spinning. Upon termination of the spin, a given symbol from the symbol set(s) will be displayed in each of the positions other than that occupied by the special symbol 312. The special symbol 312 remains static within position 2, 2.

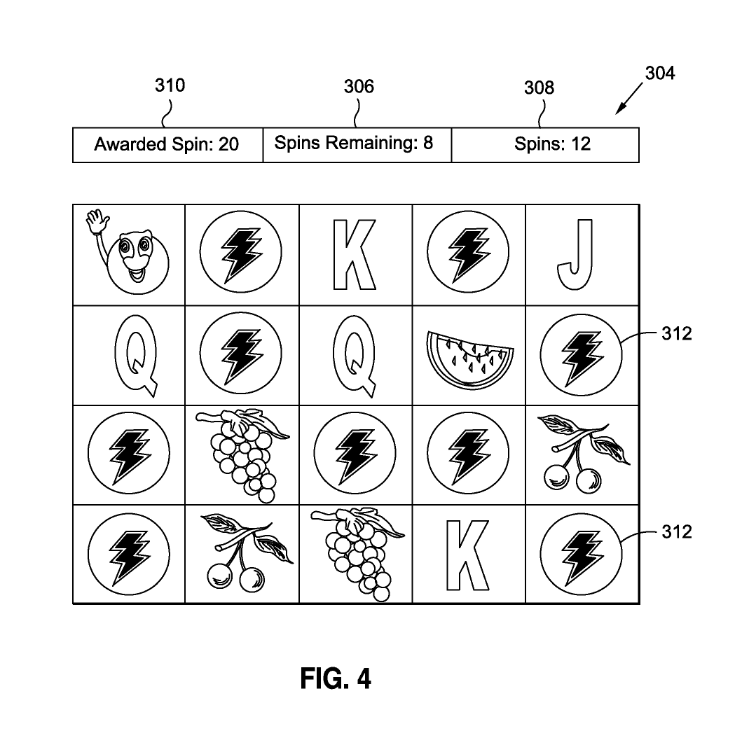

In FIG. 4, eight spins are shown to remain 306 as indicated in the meter display 304. Additional special symbols 312 have been randomly selected for generation in their respective symbol matrix positions between the spin depicted in FIG. 3(a), the second spin, and this FIG. 4, the 12^{th} spin. All of the special symbols in FIG. 4 will remain static while those that that are not special symbols will be re-spun during the next spin, since two remain. In an alternative embodiment, the re-generation of symbols may be displayed such that each symbol position appears as a mini-reel spinning independently of the others. This would provide a more aesthetic look to the bonus game once numerous special symbols were locked since spinning reels may not be easily depicted when too many must be depicted as static. In another embodiment, layered displays could adequately depict a spinning reel while maintaining the visual depiction of the special symbols 312 locked in place in their respective positions.

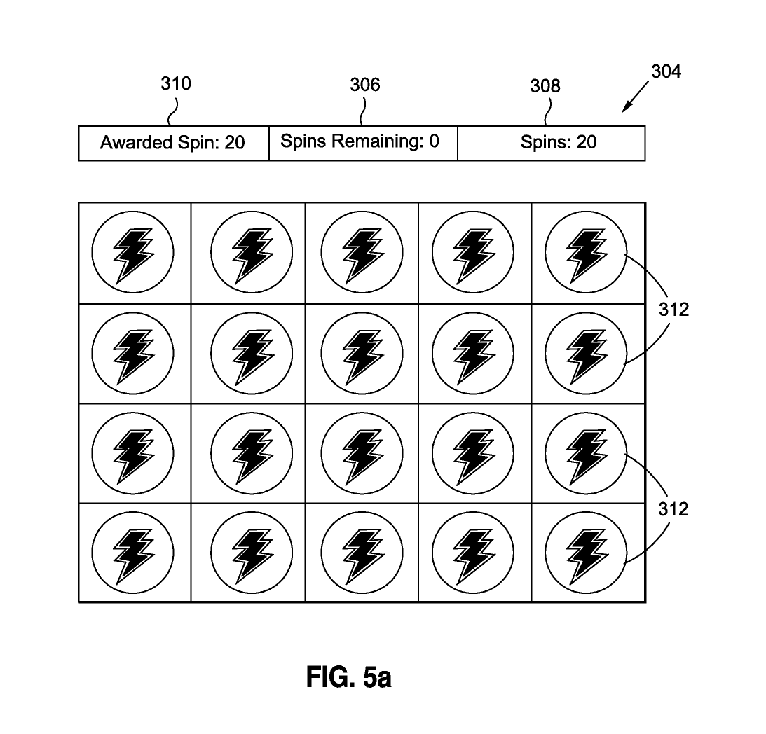

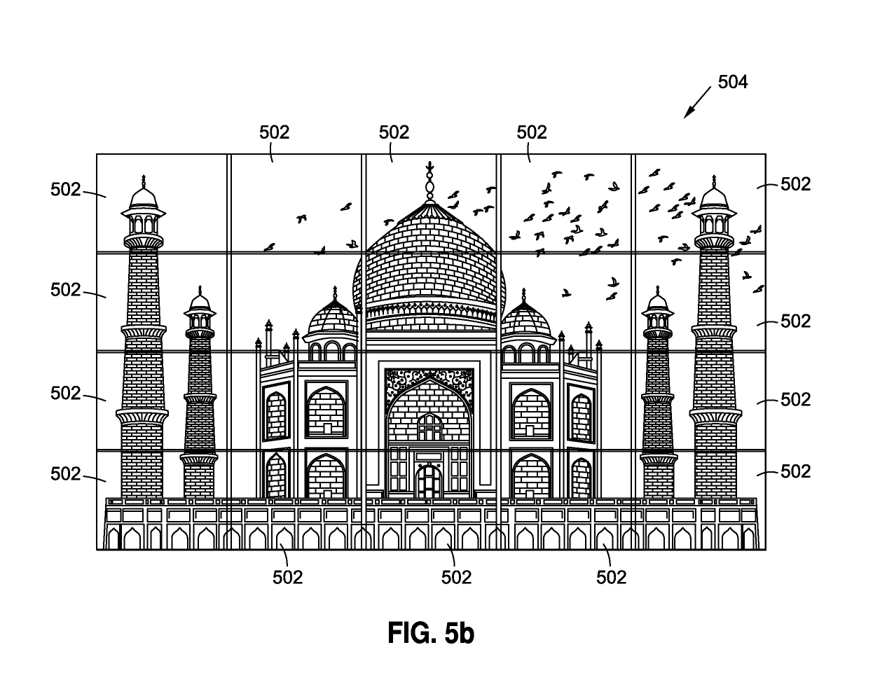

If a special symbol 312 has landed in each position of the matrix, the bonus game will end regardless of whether or not any spins remain. In one embodiment, an additional award or feature is provided if the matrix is filled with special symbols prior to the last spin of the bonus game. The value of the additional award or feature may be dependent on how many spins remain once the matrix is filled with special symbols. FIG. 5(a) displays a matrix with a special symbol 312 in each of the positions of the matrix. Each of the positions is associated with a portion of a complete image. Upon obtaining the last of the special symbols, the matrix display of 4×5 or twenty (20) special symbols converts or is re-generated into a visual image. FIG. 5(b) depicts each of the twenty (20) image pieces 502 associated with each of the matrix positions and the complete image 504.

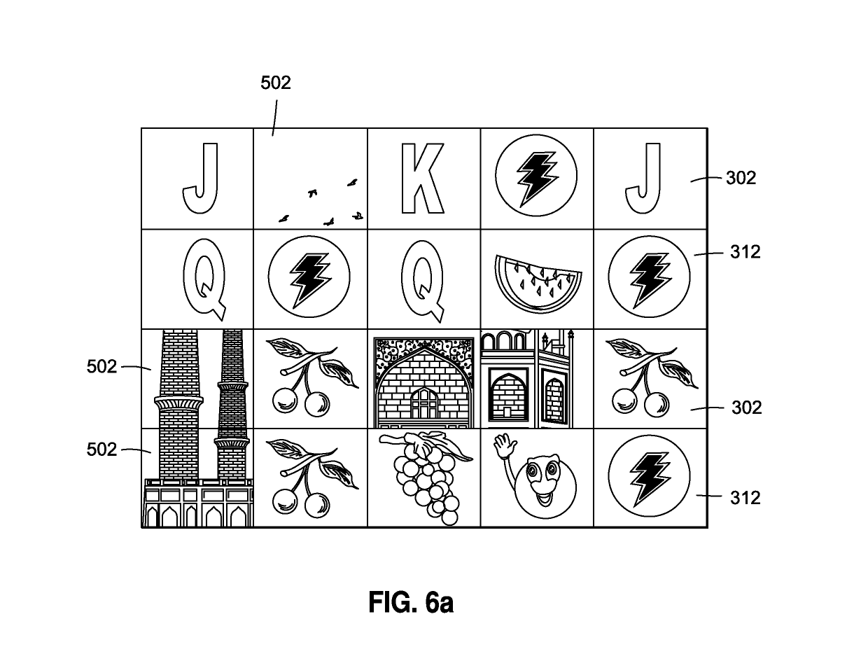

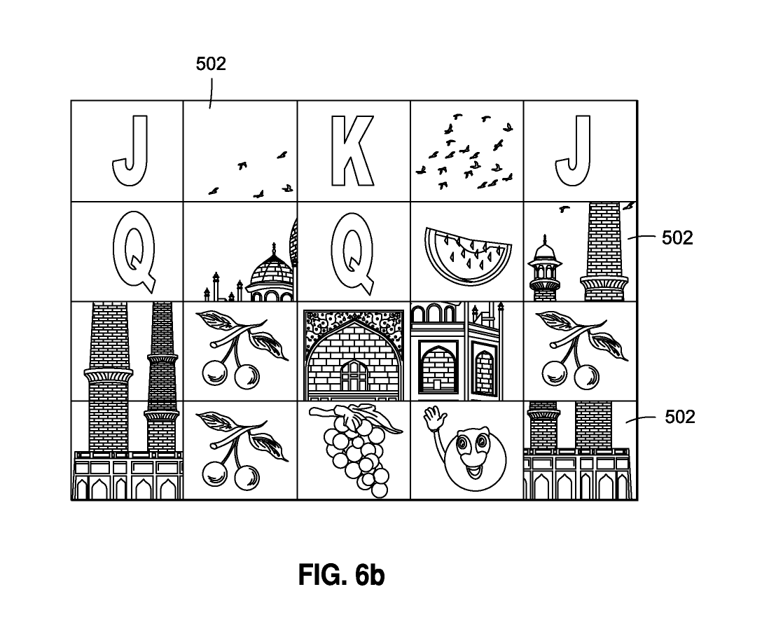

In another embodiment, as discussed above and as depicted in FIG. 6, the special symbols are converted or re-generated in to the associated image piece for the respective position upon or soon after the special symbol's generation at that position of the matrix. They remain static and locked in position through subsequent spins in the bonus game, similar to the special symbols. FIG. 6(a) shows four special symbols 312 in various positions of the matrix, at positions having just generated into those positions from the latest spin. Also shown are a five (5) of image pieces 502 at positions 3,1, 4,1, 1,2, 3,3 and 3,4 (where the first number designates the row number and the second designates the column number) that were converted or re-generated from special symbols that were generated at those positions during prior spins. In this embodiment, the image may then build through subsequent spins until the image is completed or there are no further spins remaining and the bonus game ends. FIG. 6(b) shows the special symbols, having been generated in the most recent spin, converting into additional image pieces 502 to provide now a total of nine (9) image pieces in the matrix and further completing the image.

As previously discussed, the image pieces 502 can themselves be included in the symbol set(s). The image pieces 502 associated with positions in a respective column can be included in a symbol set associated specifically with that column. Therefore, each column of the matrix would be assigned a specific symbol set which includes the image or puzzle pieces 502 associated with positions of that column. The image or puzzle pieces may have different weights of occurrence, thus making some harder to achieve generation within their respective associated positions than others. Upon generation of an image piece 502 within the respective position of the column associated with that image piece, the image piece would stick in place and remain for the remainder of free spins. Generation from the special symbol 312 to the image or puzzle piece 502 would not be needed under this particular embodiment.

Although the free spin bonus game has been described as a bonus game or feature that is complementary to a primary or base game, it should be understood that embodiments of the invention need not include a base game or a trigger to initiate play of the free spin bonus game. The free spin bonus game could operate as a standalone method, device or system, and be played on its own. In such an embodiment, the free spin bonus game and would then be not considered a bonus or secondary type of game or feature.

As one example, in one embodiment the game might be initiated with the display of a first set of symbols, with the goal being to achieve one or more winning combinations of symbols and/or one or more special symbols. If a special symbol is received, the player might be given the opportunity to play additional iterations of the game in an attempt to achieve a special symbol in all of the symbol positions or locations, thus unlocking the picture (and any associated award).

While in one embodiment a player might be assigned or given a number of spins, other versions of the game are possible (whether presented as a base game or bonus event). For example, in one embodiment, the player may only be given the opportunity to play additional iterations of the game if certain conditions are met, such as the random award of additional spins. In one embodiment, the player might be awarded an additional spin only if the player receives at least one special symbol in that spin.

While the game is preferably presented as a free spin bonus game, the game or event might be presented in other manners. For example, the player might be required to place a wager in order to participate in the bonus event or might be required to place a wager in order to engage in each and every game or spin. For example, the player might only be required to place a base wager in order to play the base game, but might be required to place a maximum wager or additional side wager in order to enable the bonus game feature (e.g. the free spin bonus game would not be triggered absent such an additional wager). As another example, once the bonus game is initiated, the player might be given a single spin and might be required to place a wager for each additional spin.

In yet another embodiment of the invention, the game or event might be a persistent game which extends across or is associated with a plurality of base games. For example, each time a player plays an occurrence of a base game the player might be awarded one or more bonus game plays. If the player has not collected or received all of the special symbols after the one or more plays, the player might be returned to the base game. If the player played the base game again (which might require another wager), then the player might be returned to the bonus game in its previous condition (e.g. with any previously collected or received special symbols or the corresponding images still in place). In this manner, a player could be enticed to play multiple base games in an attempt to return as many times as possible in order to try and collect all of the special symbols in the bonus game (and thus win any associated award).

In one embodiment of the game the images which comprise portions of the picture may be displayed in the symbols positions to which they correspond. In another embodiment, however, a first area may display the symbol positions and symbols and a second area may display a grid of corresponding image positions. As each special symbol is received, the corresponding image might be revealed in the second area.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A gaming machine comprising:
a controller;
at least one electronic display;
at least one player input device;
machine-readable code executable by said controller to cause said at least one electronic display to display a base game;
machine-readable code executable by said controller to cause said controller to accept input from said player via said at least one player input device of said gaming machine, said input comprising a wager amount;
machine-readable code executable by said controller to cause said controller to play the base game upon receiving input from said player;
machine-readable code executable by said controller to cause said controller to detect the occurrence of a trigger condition wherein said trigger condition causes said base game to suspend the play of the base game and to display at said display device a free spin bonus, said free spin bonus comprising a number of spins, a symbol set, a symbol array comprising a plurality of symbol positions for displaying in each of said symbol positions randomly selected symbols from said symbol set, and at least one special symbol within said symbol set, said special symbol associated with a locking feature that causes said special symbol to remain in said symbol position after selection for a remainder of said number of spins; wherein said controller:
(i) randomly selects a symbol from said symbol set for display in each of said symbol positions not displaying said special symbol;
(ii) reduces said number of spins by one wherein said number of spins after said reducing is said remainder;
(iii) determines if said at least one special symbol is displayed in any of the plurality of said symbol positions after the most recent random selection of symbols from said symbol set;
(iv) repeats at least (i) through (iii) if said remainder is greater than zero and no special symbols are displayed in the plurality of said symbol positions after the most recent random selection of symbols from said symbol set;
(v) locks any of said at least one special symbols displayed in any of the plurality of symbol positions in said position;
(vi) determines if said special symbol is displayed in each of said plurality of symbol positions;
(vii) repeats at least (i) through (iii) if said remainder is greater than zero and at least one position of said plurality of symbol positions contains a symbol from the symbol set other than then said special symbol;
(viii) generates when said special symbol is displayed in each of said plurality of symbol positions an image piece from a plurality of image pieces in each of said symbol positions, said image piece associated with the symbol position and said plurality of image pieces comprising a complete image associated with a bonus game award.

2. The gaming machine of claim 1, wherein the base game is a video slot game.

3. The gaming machine of claim 1, wherein said image piece associated with said symbol position from said plurality of symbol positions is displayed after the generation of said special symbol and prior to the next random generation of symbols from said symbol set.

4. The gaming machine of claim 1, wherein the bonus game award is factored relative to said wager amount.

5. A gaming system comprising:
at least one game server comprising a processor configured to execute machine readable code;
at least one communication interface which permits said game server to transmit information to a plurality of presentation computing devices and to receive information from a plurality of presentation computing devices;
a base game configured to be displayed at one or more of said plurality of presentation computing devices through the execution by said processor of said machine readable code;
at least one input device at said plurality of presentation computing devices to input data associated with a wager amount on said base game at each of said one or more plurality of presentation computing devices, and to initiate the display and play of said base game;
a trigger condition detectable by said controller wherein said trigger condition causes said controller to suspend the play of said base game and display at said display device a free spin bonus, said free spin bonus comprising a number of spins, a symbol set, a symbol array comprising a plurality of symbol positions for displaying in each of said symbol positions randomly generated symbols from said symbol set, and at least one special symbol within said symbol set, said special symbol associated with a locking feature that causes said special symbol to remain in said symbol position once randomly generated therein for a remainder of said number of spins; wherein said controller:
(i) randomly generates a symbol from said symbol set for display in each of said symbol positions not displaying said special symbol;
(ii) reduces said number of spins by one wherein said number of spins after said reducing is said remainder;
(iii) determines if said at least one special symbol is displayed in any of the plurality of said symbol positions after the most recent random generation of symbols from said symbol set;
(iv) repeats at least (i) through (iii) if remainder is greater than zero and no special symbols are displayed in the plurality of said symbol positions as a result of the most recent random generation of symbols from said symbol set;
(v) locks any of said at least one special symbols displayed in any of the plurality of symbol positions in said position;
(vi) determines if said special symbol is displayed in each of said plurality of symbol positions;
(vii) repeats at least (i) through (iii) if said remainder is greater than zero and at least one position of said plurality of symbol positions contains a symbol from the symbol set other than then said special symbol;
(viii) generates when said special symbol is displayed in each of said plurality of symbol positions an image piece from a plurality of image pieces in each of said symbol positions, said image piece associated with the symbol position and said plurality of image pieces comprising a complete image associated with a bonus game award.

6. The gaming system of claim 5, further comprising:
at least one data storage device configured to store media information regarding a plurality of users, each user identifiable by a user account, wherein said data comprising media information associated with said user account is input in association with said wager amount.

7. The gaming system of claim 5, wherein said wager amount is associated with virtual currency.

8. The gaming system of claim 5, wherein the base game is a video slot game.

9. The gaming system of claim 5, wherein said image piece associated with said symbol position from said plurality of symbol positions is displayed after the generation of said special symbol and prior to the next random generation of symbols from said symbol set.

10. The gaming system of claim 5, wherein the said bonus game award is factored relative to said wager amount.

11. A method for playing a game on a gaming device comprising a memory device for storing computer coded instructions for playing said game, a processor for processing said computer coded instructions, at least one input device for delivering input to the processor to control aspects of the play of said game, and at least one display device for displaying said game, the method comprising:
displaying said game on said at least one display device;
making a wager through said at least one input device to play said game, wherein said game is a free spin game comprising a number of spins, a symbol set, a symbol array comprising a plurality of symbol positions for displaying in each of said symbol positions randomly generated symbols from said symbol set, and at least one special symbol within said symbols set, said special symbol associated with a locking feature that causes said special symbol to remain in said symbol position once randomly generated therein for a remainder of said number of spins;
randomly selecting a symbol for each of said plurality of symbol positions from said symbol set and displaying each of said selected symbols in association with said symbol position;
reducing said number of spins by one wherein said number of spins after said reducing is said remainder;
determining if said at least one special symbol is displayed in any of said plurality symbol positions after the most recent selection of symbols from said symbol set;
randomly re-selecting a symbol for each of said plurality of symbol positions from said symbol set and displaying each of said selected symbols in association with said symbol position if said remainder is greater than zero and said special symbols are not displayed in each of said plurality of symbol positions after the most recent random selection of symbols from said symbol set;
locking any of said at least one special symbol displayed in any of said plurality of symbol positions in said position;
determining if said special symbol is displayed in each of said plurality of symbol positions;
randomly re-selecting a symbol for each of said symbol positions from said symbol set and displaying each of said selected symbols in association with said symbol position if said remainder is greater than zero and at least one position of said plurality of symbol positions contains a symbol from the symbol set other than said special symbol;
generating when said special symbol is displayed in each of said plurality of symbol positions an image piece from a plurality of image pieces in each of said symbol positions, said image piece associated with the symbol position and said plurality of image pieces comprising a complete image associated with a bonus game award.

12. The method of claim 11, wherein said image piece associated with said symbol position from said plurality of symbol positions is displayed after the selection of said special symbol and prior to the next random selection of symbols from said symbol set.

13. The method of claim 11, wherein the said bonus game award is factored relative to said wager amount.

14. The method of claim 11, wherein randomly selecting and re-selecting a symbol for each of said symbol positions from said symbol set and displaying each of said selected symbols in association with said symbol position is automatic.
